(19) United States
(12) Patent Application Publication
(10) Pub. No.: US 2018/0048932 A1
(43) Pub. Date: Feb. 15, 2018

(54) SIGNALING METHODS AND APPARATUS

(71) Applicant: SONY CORPORATION, Tokyo (JP)

(72) Inventors: Mark EYER, Tokyo (JP); Luke FAY, Tokyo (JP)

(73) Assignee: SONY CORPORATION, Tokyo (JP)

(21) Appl. No.: 15/237,242

(22) Filed: Aug. 15, 2016

(51) Int. Cl. H04N 21/434; H04N 21/63; H04N 21/643

(52) U.S. Cl. CPC H04N 21/4345; H04N 21/64322; H04N 21/63

(57) ABSTRACT

A reception apparatus and method for provider signaling. The method includes receiving a portion of a broadcast stream including low level signaling (LLS) information. The LLS information includes a provider count field. The method further includes extracting using circuitry a value of the provider count field. The provider count field identifies the number of different providers that provide LLS information in the portion of the broadcast stream. In addition, the method includes determining the number of providers based on the value of the provider count field and processing the portion of the broadcast stream to extract the LLS information until the LLS information for each of the different providers is extracted based on the determined number of providers.

### TECHNICAL FIELD

The present disclosure relates to methods and apparatuses for provider signaling in a broadcasting system.

### BACKGROUND

Television broadcasting has evolved from basic analogue terrestrial broadcast television to complex digital systems. Future broadcasting standards may allow many modes of operations to be determined by the broadcaster. Thus, signaling information may be needed by the receiver to decode efficiently, and correctly the received data.

The foregoing “Background” description is for the purpose of generally presenting the context of the disclosure. Work of the inventor, to the extent it is described in this background section, as well as aspects of the description which may not otherwise qualify as prior art at the time of filing, are neither expressly or impliedly admitted as prior art against the present invention.

### SUMMARY

According to an embodiment of the present disclosure, there is provided a method for provider signaling. The method includes receiving a portion of a broadcast stream including low level signaling (LLS) information. The LLS information includes a provider count field. The method further includes extracting using circuitry a value of the provider count field. The provider count field identifies the number of different providers that provide LLS information in the portion of the broadcast stream. In addition, the method includes determining the number of providers based on the value of the provider count field and processing the portion of the broadcast stream to extract the LLS information until the LLS information for each of the different providers is extracted based on the determined number of providers.

According to an embodiment of the present disclosure, there is provided a reception apparatus, including circuitry. The circuitry is configured to receive a portion of a broadcast stream including low level signaling (LLS) information. The LLS information includes a provider count field. The circuitry is further configured to extract a value of the provider count field. The provider count field identifies the number of different providers that provide LLS information in the portion of the broadcast stream. In addition, the circuitry is further configured to determine the number of providers based on the value of the provider count field and to process the portion of the broadcast stream to extract the LLS information until the LLS information for each of the different providers is extracted based on the determined number of providers.

According to an embodiment of the present disclosure, there is provided a non-transitory computer-readable medium storing instructions, which when executed by a computer, causes the computer to perform the method for provider signaling, as described above.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a block diagram that shows an exemplary broadcasting system;

FIG. 2 illustrates an exemplary bit stream syntax of a portion of an LLS_table( );

FIG. 3 is an exemplary illustration of PLPs (physical layer pipes) sharing between a plurality of providers according to one example;

FIG. 4 is a flowchart that shows the operation of a transmitter according to one example;

FIG. 5 is a flowchart that shows the operation of a reception apparatus according to one example;

FIG. 6 illustrates an exemplary reception apparatus; and

FIG. 7 is a block diagram showing an example of a hardware configuration of a computer.

### DETAILED DESCRIPTION

Referring now to the drawings, wherein like reference numerals designate identical or corresponding parts throughout several views, the following description relates to apparatus and methods for provider identification signaling. The method signals the number of different providers providing data in a portion of a stream (e.g., a given LLS Channel) to reception apparatuses.

While the present disclosure is susceptible of embodiment in many different forms, there is shown in the drawings and will herein be described in detail specific embodiments, with the understanding that the present disclosure of such embodiments is to be considered as an example of the principles and not intended to limit the present disclosure to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or similar terms, as used herein, is defined as a sequence of instructions designed for execution on a computer system. A “program”, or “computer program”, may include a subroutine, a program module, a script, a function, a procedure, an object method, an object implementation, in an executable application, an applet, a servlet, a source code, an object code, a shared library/dynamic load library and/or other sequence of instructions designed for execution on a computer system.

Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

The following description relates to methods and apparatuses for signaling provider information in a communication system.

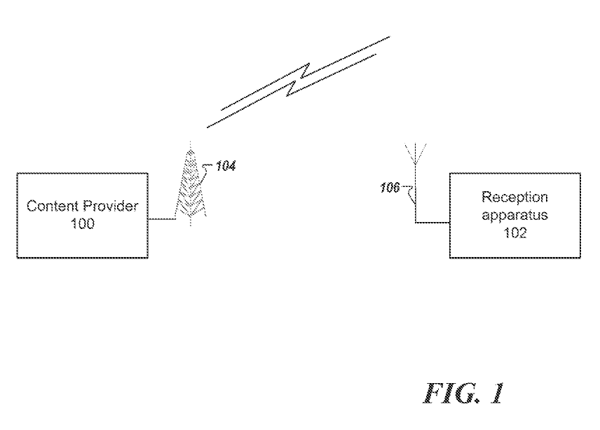

FIG. 1 is an exemplary system for broadcasting and receiving communication signals according to one example. The communication signals may represent data where the communication signals may be digital television signals (e.g., terrestrial television broadcast signals). The communication system includes a content provider 100 and a reception apparatus 102. In one example, the content provider (e.g., a broadcaster entity, service provider, or broadcast station) 100 includes a transmission apparatus with a transmitter that is configured to transmit one or more content to the reception apparatus 102.

The transmitter may include a source encoder, a channel encoder, and a modulator. The source encoder may include a data, audio, and video encoders to compress the audio, video, signaling, control or other data received from a source. The channel encoder may randomize, interlace, channel code, and frame map the compressed and signaling data. For example, the channel encoder may include a frame builder that forms many data cells into sequences to be conveyed on OFDM (Orthogonal frequency-division multiplexing) symbols. The modulator (multiplexer) converts the processed digital data into modulation symbols, which can be, for example OFDM symbols (e.g., in the case of the proposed ATSC 3.0 standard). The multiplexed data is then passed to an IFFT (inverse fast Fourier transformer) which transforms a frequency domain signal into a time domain signal. The time domain signal is fed to a guard insertion module for generating a GI (guard interval) between symbols and then to a D/A (digital to analog) converter. Then, antenna 104 may perform up-conversion, RF amplification and over-the air broadcasting.

In certain embodiments, some of the components of the transmission apparatus or the reception apparatus may not be necessary. For example, the antennas are not required when the transmission system is not over-the-air but over cable. Details of an OFDM transmitter and receiver may be found, for example, in the DVB-T2 standard (ETSI EN 302 755), ATSC Proposed Standard: Physical Layer Protocol (A/322), Doc. S32-230r56, 29 Jun. 2016, and ATSC Standard: A/321, System Discovery and Signaling, Doc. A/321:2016, 23 Mar. 2016 each incorporated herein by reference in its entirety.

The reception apparatus 102 may include a television set, mobile handsets, personal video recorders, a computer, a vehicle, or others devices configured to receive a communication signal. The reception apparatus 102 includes an antenna 106 to receive the communication signal in certain embodiments.

The signals carrying the data may be transmitted to the reception apparatus 102 over a terrestrial broadcast, broadband networks, a cable connection and/or a satellite link. The system may use any one or a variety of transmission techniques to communicate data to user devices, for example the system may use a single or multicarrier technique.

The content provider 100 may provide information that receivers may need to discover and acquire services in a RF (Radio Frequency) emission or other data stream.

A physical layer provides the mechanism by which signaling, service announcement and IP packet streams are transported over the broadcast physical layer or broadband physical layer. Signaling information that is carried in the payload of IP (Internet protocol) packets with a predefined address/port dedicated to this function is referred to as LLS (Low Level Signaling). The LLS information may include SLT (Service List Table), RRT (Rating Region Table), and systemTime fragment. The LLS information may be carried in the form of a LLS table, which may be provided in eXtensible Markup Language (XML) format and compressed for transmission.

A PLP (physical Layer Pipe) corresponds to a portion of a RF channel. Each PLP may have certain modulation and coding parameters. The PLP is identified by a PLPID (PLP identifier), which is unique within a broadcast stream.

One or more content providers may use a single PLP for signaling. This allows, for example, different content providers to share the same broadcast tower and/or other broadcast equipment (e.g., encoders/multiplexers infrastructure that are used for a given PLP). One PLP in the broadcast that delivers LLS tables (one LLS Channel) may be shared by multiple providers. Thus, one or more providers may provide signaling tables that appear in the same IP packets carrying the LLS. A given LLS table instance can be associated with one of the providers by a field called “provider ID”.

A problem occurs when a receiver wishes to collect all available LLS data, but does not know how many different providers are included and offering data of a given type (e.g., SLT, RRT, etc.). Therefore, the reception apparatus 102 may not be able to determine whether or when all available SLT data, for example, from the different providers has been collected from the LLS packet stream. Thus, the reception apparatus 102 may wait an inordinate amount of time before determining, or assuming, that no more LLS data will be forthcoming.

A common situation where receivers collect LLS data is during a “channel scan” operation used to derive a list of all Services available to the reception apparatus 102 from one or more RF sources (e.g., using the SLT). If the reception apparatus 102 could know how many providers are present in a given LLS stream, then the reception apparatus 102 may optimize the collection of LLS and speed up the channel scan by avoiding unnecessary waiting.

The SLT includes information used in the channel scan that allows the reception apparatus 102 to build a list of all the services that can be received by the reception apparatus 102, with the channel name and channel number associated with each service. In addition, the SLT includes bootstrap information used by receivers to discover the SLS (service layer signaling) for each service. The SLT supports channel scans and service acquisition by including the following information about each service in the broadcast stream: information used in the presentation of a service list that is meaningful to viewers and that can support initial service selection via channel number or up/down selection and information used to locate the service layer signaling for each service listed. An exemplary SLT XML format is described in ATSC Candidate Standard: Signaling, Delivery, Synchronization, and Error Protection (A/331), Doc. S33-174r3, 21 Jun. 2016 incorporated herein by reference in its entirety.

Table 1 shows an exemplary syntax for an LLS table.

TABLE 1
Common Bit Stream Syntax for LLS Tables

| | No. of | |
|---|---|---|
| Syntax | Bits | Format |
| LLS_table( ) { | | |
| LLS_table_id | 8 | uimsbf |
| provider_id | 8 | uimsbf |
| LLS_table_version | 8 | uimsbf |
| switch (LLS_table_id) { | | |
| case 0x01: | | |
| SLT | var | |
| break; | | |
| case 0x02: | | |
| RRT | var | |
| break; | | |
| case 0x03: | | |
| SystemTime | var | |
| break; | | |
| default: | | |
| Reserved | var | |
| } | | |
| } | | |

The LLS_table ( ) includes a LLS_table_id (e.g., 0x01, 0x02, 0x03), a provider_id, and a LLS_table_version. The LLS_table ( ) may also include SLT, RRT, and SystemTime, each associated with a particular LLS_table_version as described in ATSC Candidate Standard: Signaling, Delivery, Synchronization, and Error Protection (A/331), Doc. S33-174r3, 21 Jun. 2016 incorporated herein by reference in its entirety.

Exemplary descriptions of the fields included in the bit stream syntax for LLS tables are as follows:

LLS_table_id—An 8-bit unsigned integer that identifies the type of table delivered in the body.
provider_id—An 8-bit unsigned integer that identifies the provider that is associated with the services signaled in this instance of LLS_table ( ), where a “provider” is a broadcaster that is using part or all of this broadcast stream to broadcast services. The value of provider_id is unique within this broadcast stream.
LLS_table_version—An 8-bit unsigned integer that is incremented by 1 whenever any data in the table identified by table_id changes. When the value reaches 0xFF, the value wraps to 0x00 upon incrementing.
SLT—The XML format Service List Table, compressed with gzip.
RRT—An instance of a Rating Region Table conforming to the RatingRegionTables structure, compressed with gzip.

SystemTime—The XML format System Time fragment, compressed with gzip.

In one example, the maximum possible of PLP's in a RF emission may be limited to a predetermined number. For example, the maximum possible number of PLPs in a given RF emission may be 64 as constrained in ATSC Proposed Standard: Physical Layer Protocol (A/322), Doc. 532-230r56, 29 Jun. 2016 incorporated herein by reference in its entirety.

In addition, the number of PLP's in a physical layer frame requiring simultaneous recovery to assemble a broadcast product may be limited. For example, the maximum number of PLPs in a physical layer frame requiring simultaneous recovery to assemble a broadcast product (service) is four. Setting a limit of a maximum of 16 providers allowed in one allocated RF channel emission is reasonable based on these factors. The scope of uniqueness of provider_id is across the broadcast emission. However, no more than 16 different providers may ever need or desire to share the same broadcast emission (e.g., 6 MHz broadcast emission) due to capacity limitations with sharing. Therefore, provider_id can be represented as a 4-bit number instead of an 8-bit number.

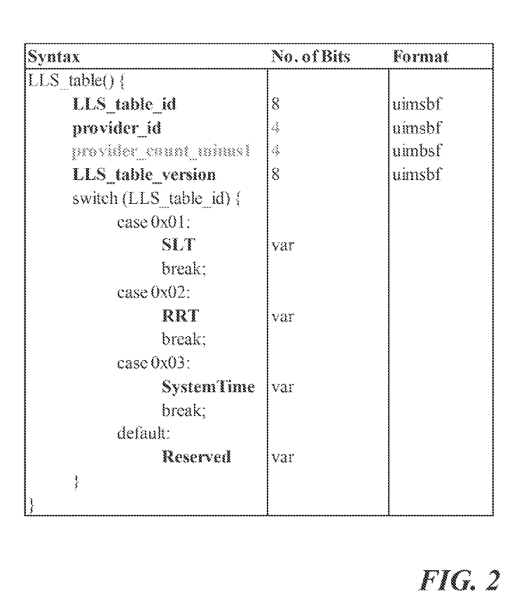

A second field may indicate the number of providers sending LLS data in the LLS packet stream. In one embodiment, the remaining 4-bits of the provider_id are used for the second field. The value of the second field may be a function of the number of providers. In one embodiment, the second field may be a “provider_count_minus1” field provided in the bit stream syntax for LLS tables as shown in FIG. 2. The field includes information that indicates the number of providers supplying LLS tables in the LLS packet stream, for example for a given PLP. The value of the field may be equal to the number of providers minus one, the number of providers, or other representations. The provider_id field may be 4-bits. In addition, the “provider_count_minus1” field may be 4-bits.

Exemplary descriptions of the fields included in the bit stream syntax for LLS tables are as follows:

provider_id—A 4-bit unsigned integer that shall identify the provider that is associated with the services signaled in this instance of LLS_table ( ), where a “provider” is a broadcaster that is using part or all of this broadcast stream to broadcast services. The provider_id shall be unique within this broadcast stream.
provider_count_minus1—A 4-bit unsigned integer that shall indicate one less than the total number of different providers supplying LLS tables in this LLS packet stream. A value 0 indicates that LLS_table ( )s carrying only one value of provider_id will be present, a value of 1 indicates that two are present, etc.

In certain aspects, providers can be split across different PLPs as well, therefore the predetermined number of bits available to indicate the provider ID (e.g., 8 bit provider_id) value can be split in different ways. In one example, five bits may be used for provider_id and three bits for the provider_count_minus1, when there is a need to account for more providers available across more PLPs, and where each pipe has less available slots for provider LLS table signaling. The configuration of how the provider ID is split may be predefined and stored in a memory of the reception apparatus 102. The configuration may be associated with a given PLP. In one embodiment, the configuration may be signaled to the reception apparatus by a third field.

The field provider_id_minus1 informs the reception apparatus 102 of the total number of different sets of LLS tables that are present, where each different provider can provide a different set of tables. With this knowledge, the reception apparatus 102 can know when all LLS tables have been retrieved, and not waste time waiting for something that may or may not arrive.

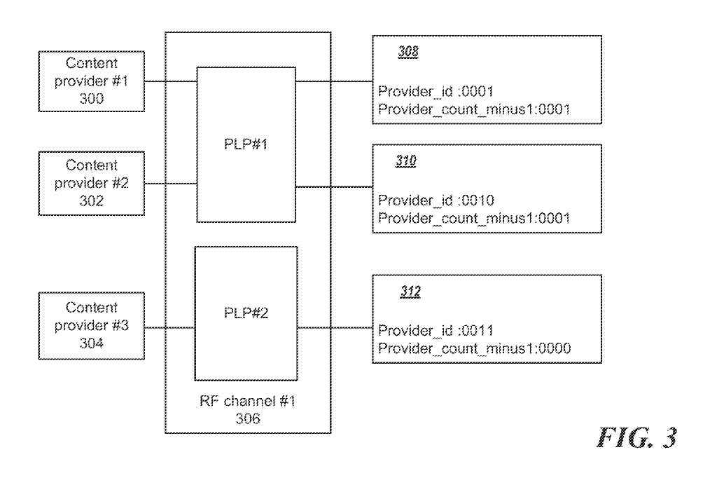

FIG. 3 is an exemplary illustration of PLP sharing between a plurality of providers according to one example. As shown in FIG. 3, the system may include a first content provider 300, a second content provider 302, and a third content provider 304. The providers 300, 302, 304 may share the same physical layer 306, for example, RF channel #1. In addition, the first content provider 300 and the second content provider 302 may share a first PLP. The third content provider 304 may use a second PLP. Table 308 shows the LLS information associated with the first content provider 300. Table 310 shows the LLS information associated with the second content provider 302. Table 312 shows the LLS information associated with the third content provider 304. In table 308, the provider_count_minus1 value is 0001 which indicates that the number of providers supplying LLS tables are two (i.e., number of providers=1+1=2). In table 312, the provider_count_minus1 value is 0000 which indicates that the number of providers is one (i.e., number of providers=0+1=1). Thus, as described further below, when the reception apparatus 102 determines that the number of providers is one in the stream then once the reception apparatus 102 detects LLS data associated with one provider, the reception process may continue.

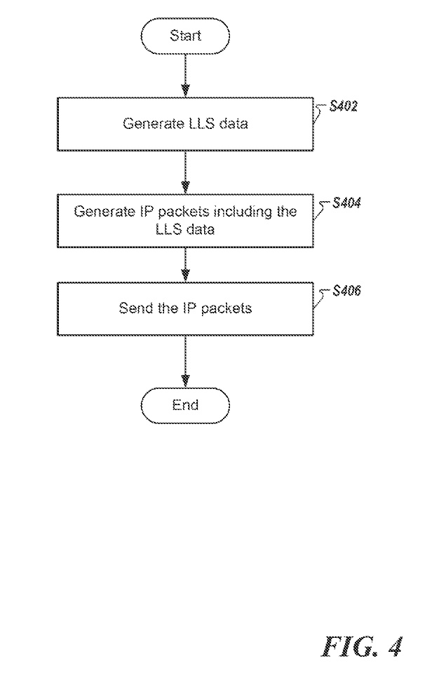

FIG. 4 is a flowchart that shows the operation of the transmitter according to one example. At step S402, the content provider 100 may generate LLS data using the syntax shown in FIG. 2. The content provider 100 may determine a value for the provider_count_minus1 field based on predefined settings for a LLS stream. At step S404, the content provider 100 may generate IP packets. The payloads of the IP packets include the LLS data. The IP packets have a predetermined address and destination port. Then, at step S406, the content provider 100 sends the IP packets via the physical layer.

Each content provider (e.g., broadcasting entities) may generate their own LLS data without relying on other providers sharing the PLP. Thus, each provider may use a different set of parameters (e.g., encoding parameters, modulation parameters, redundancy).

In one example, a tuner of the reception apparatus 102 may step through frequencies using a predefined frequency list. For each frequency, the tuner may determine whether a signal is present. When a signal at a given frequency is detected, the reception apparatus 102 gets the RF stream and passes it to a processor to extract signaling data. In another example, the signaling data is extracted when the tuner tunes to a channel selected by a user.

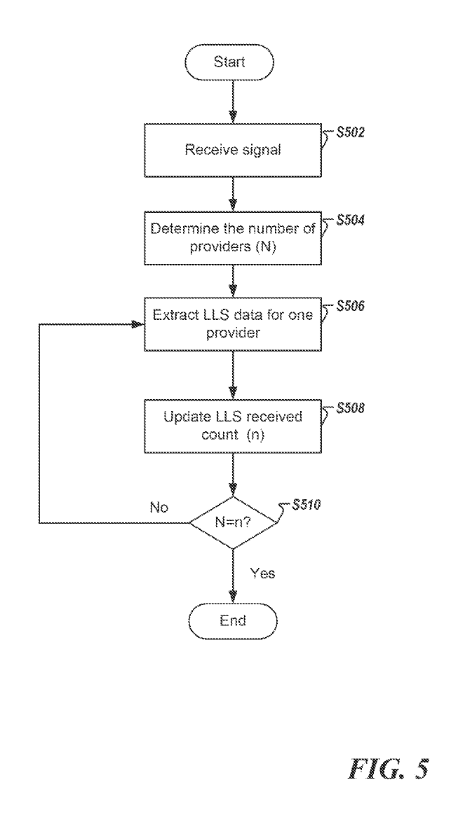

FIG. 5 is a flowchart that shows the operation of the reception apparatus 102 according to one example. At step S502, the reception apparatus 102 may receive a portion of a broadcast stream including low level signaling (LLS) information. The LLS information includes a provider count field (e.g., provider_count). The provider count field identifies the number of different providers that provide LLS information in one portion of the broadcast stream, called an “LLS Channel” in one embodiment. Each broadcast emission may carry one or more LLS Channels. Then, at step S504, the reception apparatus 102 extracts the value of the provider count field. As described previously herein, the provider count field identifies, for example, the number of different providers providing services in a PLP. Then, the reception apparatus 102 determines the number of providers as a function of the value of the broadcaster count field. The number of providers is associated with the number of different LLS data (e.g., tables) the reception apparatus 102 may expect. In one embodiment, the provider count field may represent the number of providers minus one.

At step S506, the reception apparatus 102 may extract a first LLS table associated with a first provider. Then, at step S508, the reception apparatus 102 may update a count. The count represents the number of LLS tables received. At step S510, the reception apparatus 102 may compare the count with the number of providers determined at step S504. In response to determining that the number of providers is equal to the count (i.e., number of tables received so far), the process ends. In response to determining that the count is less than the number of providers, the process goes back to S506, where the reception apparatus 102 may continue to wait for another LLS table from the LLS packet stream. Once the expected number of tables is extracted, the reception apparatus 102 determines that all tables have been extracted and can terminate the LLS table extraction process.

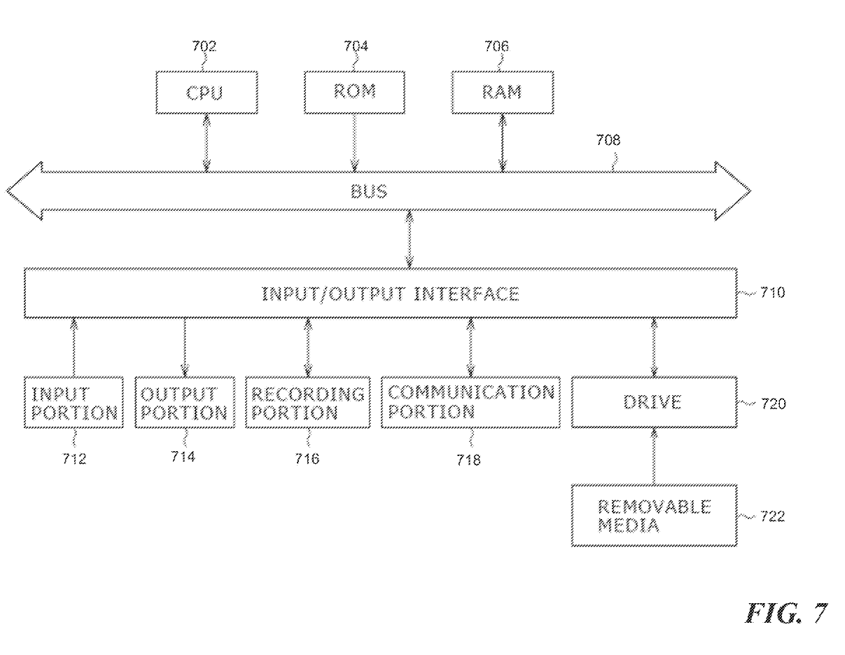

The reception apparatus 102 illustrated in FIG. 1 generally operates under control of at least one processor, such as a CPU (central processing unit), which is coupled to memory, program memory, and a graphics subsystem via one or more buses. An exemplary computer for controlling the reception apparatus 102 is further described below with respect to FIG. 7. Similarly, the content provider 100 illustrated in FIG. 1 is operated under control of at least one processor.

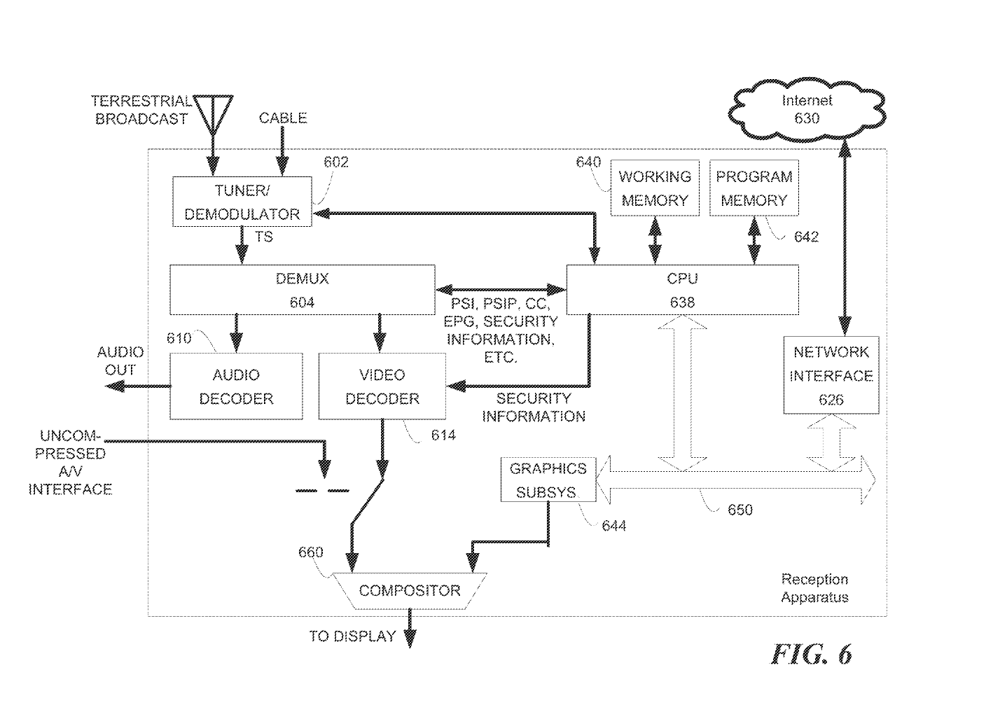

FIG. 6 illustrates an exemplary reception apparatus 102, which is configured to implement the process of FIG. 5 in certain embodiments. The reception apparatus 102 includes a digital television receiver device that is incorporated into a fixed or mobile device such as a television set, a set top box, smartphone, tablet computer, laptop, portable computer, or any other device configured to receive television content. The reception apparatus may also be incorporated in a vehicle.

The reception apparatus includes a tuner/demodulator 602, which receives digital television broadcast signals from one or more content sources (e.g., content source) via, for example, a terrestrial broadcast. Depending on the embodiment, the reception apparatus may alternatively or additionally be configured to receive a cable television transmission or a satellite broadcast. The tuner/demodulator 602 receives a signal, including for example an MPEG-2 TS or IP packets, which may be demultiplexed by the demultiplexer 604 or handled by middleware and separated into (A/V) (audio and video) streams. The audio is decoded by an audio decoder 610 and the video is decoded by a video decoder 614. Further, uncompressed A/V data may be received via an uncompressed A/V interface (e.g., a HDMI interface), if available.

In one embodiment, the received signal (or stream) includes supplemental data such as one or a combination of closed caption data, an application associated with the received content, a trigger, a virtual channel table, EPG data, NRT content, etc. Examples of the application (e.g., a TDO (triggered declarative object)) and trigger are described in ATSC Standard: Interactive Services Standard (A/105:29 Oct. 2015), which is incorporated herein by reference in its entirety. The supplemental data are separated out by the demultiplexer 604. However, the A/V content and/or the supplemental data may be received via the Internet 630 and a network interface 626.

A memory may be provided to store NRT (non real time content) or IPTV (Internet-delivered content such as Internet Protocol Television). The stored content can be played by demultiplexing the content stored in the memory by the demultiplexer 604 in a manner similar to that of other sources of content. Alternatively, the stored content may be processed and presented to the user by the CPU 638. The memory may also store any other supplemental data acquired by the reception apparatus.

The reception apparatus generally operates under control of at least one processor, such as the CPU 638, which is coupled to a working memory 640, program memory 642, and a graphics subsystem 644 via one or more buses (e.g., bus 650). The CPU 638 receives closed caption data from the demultiplexer 604 as well as any other supplemental data used for rendering graphics, and passes appropriate instructions and data to the graphics subsystem 644. The graphics outputted by the graphics subsystem 644 are combined with video images by the compositor and video interface 660 to produce an output suitable for display on a video display.

Further, the CPU 638 operates to carry out functions of the reception apparatus including the processing of NRT content, triggers, applications, EPG data, etc. For example, the CPU 638 operates to execute script objects (control objects) contained in the application (e.g., HTML5 application), its trigger(s), etc., using for example a browser stored in the program memory 642.

Although not illustrated in FIG. 6, the CPU 638 may be coupled to any one or a combination of the reception apparatus 102 resources to centralize control of one or more functions. In one embodiment, the CPU 638 also operates to oversee control of the reception apparatus including the tuner/demodulator 602 and other television resources.

FIG. 7 is a block diagram showing an example of a hardware configuration of a computer that can be configured to perform functions of any one or a combination of reception apparatus and transmission apparatus. For example, in one embodiment, the computer is configured to perform the functions in the digital domain, such as the modulator, channel encoder, demodulator, the transmitter, or the reception apparatus illustrated in FIG. 6.

As illustrated in FIG. 7 the computer includes a CPU 702, ROM (read only memory) 704, and a RAM (random access memory) 706 interconnected to each other via one or more buses 708. The one or more buses 708 are further connected with an input-output interface 710. The input-output interface 710 is connected with an input portion 712 formed by a keyboard, a mouse, a microphone, remote controller, etc. The input-output interface 710 is also connected an output portion 714 formed by an audio interface, video interface, display, speaker and the like; a recording portion 716 formed by a hard disk, a non-volatile memory or other non-transitory computer readable storage medium; a communication portion 718 formed by a network interface, modem, USB interface, fire wire interface, etc.; and a drive 720 for driving removable media 722 such as a magnetic disk, an optical disk, a magneto-optical disk, a semiconductor memory, etc.

According to one embodiment, the CPU 702 loads a program stored in the recording portion 716 into the RAM 706 via the input-output interface 710 and the bus 708, and then executes a program configured to provide the functionality of the one or combination of the perform the functions in the digital domain, such as the modulator, channel encoder, demodulator, the transmitter, or the reception apparatus 102 illustrated in FIG. 6.

The hardware description above, exemplified by any one of the structure examples shown in FIGS. 6 and 7, constitutes or includes specialized corresponding structure that is programmed or configured to perform the algorithm shown in FIGS. 4 and 5. For example, the algorithm shown in FIG. 5 may be completely performed by the circuitry included in the single device shown in FIG. 6.

A system that includes the features in the foregoing description provides numerous advantages. In particular, the methodologies described herein may be employed to signal the number of providers at a plurality of levels in a broadcasting system.

Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present disclosure. As will be understood by those skilled in the art, the present invention may be embodied in other specific forms without departing from the spirit or essential characteristics thereof. Accordingly, the disclosure of the present invention is intended to be illustrative, but not limiting of the scope of the present disclosure, as well as other claims. The disclosure, including any readily discernible variants of the teachings herein, defines, in part, the scope of the foregoing claim terminology such that no inventive subject matter is dedicated to the public.

The above disclosure also encompasses the embodiments listed below.

(1) A method of a reception apparatus, the method including receiving a portion of a broadcast stream including low level signaling (LLS) information, the LLS information including a provider count field; extracting, by circuitry of the reception apparatus, a value of the provider count field, the provider count field identifying the number of different providers that provide LLS information in the portion of the broadcast stream; determining the number of providers based on the value of the provider count field; and processing the portion of the broadcast stream to extract the LLS information until the LLS information for each of the different providers is extracted based on the determined number of providers.

(2) The method of feature (1), in which the LLS information is a LLS table that includes a service list table, a rating region table, or system time information.

(3) The method of feature (2), in which the LLS table includes at least a provider ID, and the provider count field identifies the provider count minus one.

(4) The method of feature (2) or (3), in which the step of processing includes for each LLS table retrieved from the portion of the broadcast stream, comparing the number of retrieved LLS tables with the number of providers; and continuing to wait for one or more additional LLS tables in the portion of the broadcast stream when the number of retrieved LLS tables is less than the determined number of providers.

(5) The method of any of features (1) to (4), further including receiving a digital television broadcast that includes the portion of the broadcast stream.

(6) The method of any of features (1) to (5), in which the portion of the broadcast stream is a stream of IP packets, the portion of the broadcast stream being identified by a predetermined PLP ID, IP address and port number.

(7) The method of feature (6), in which the LLS information is carried in the payload of the IP packets.

(8) A reception apparatus, including circuitry configured to: receive a portion of a broadcast stream including low level signaling (LLS) information, the LLS information including a provider count field, extract a value of the provider count field, the provider count field identifying the number of different providers that provide LLS information in the portion of the broadcast stream, determine the number of providers based on the value of the provider count field, and process the portion of the broadcast stream to extract the LLS information until the LLS information for each of the different providers is extracted based on the determined number of providers.

(9) The reception apparatus of feature (8), in which the LLS information is a LLS table that includes a service list table, a rating region table, or system time information.

(10) The reception apparatus of feature (9), in which the LLS table includes at least a provider ID, and the provider count field identifies the provider count minus one.

(11) The reception apparatus of feature (9) or (10), in which the circuitry is further configured to: for each LLS table retrieved from the portion of the broadcast stream, compare the number of retrieved LLS tables with the number of providers; and continue to wait for one or more additional LLS tables in the portion of the broadcast stream when the number of retrieved LLS tables is less than the determined number of providers.

(12) The reception apparatus of any of features (9) to (11), in which the circuitry is further configured to receive a digital television broadcast that includes the portion of the broadcast stream.

(13) The reception apparatus of any of features (9) to (12), in which the portion of the broadcast stream is a stream of IP packets, the portion of the broadcast stream being identified by a predetermined PLP ID, IP address and port number.

(14) The reception apparatus of feature (13), in which the LLS information is carried in the payload of the IP packets.

(15) A non-transitory computer-readable medium storing instructions, which when executed by at least one processor cause the at least one processor to perform the method of any of features (1) to (7).

1. A method of a reception apparatus, the method comprising:
receiving a portion of a broadcast stream including low level signaling (LLS) information, the LLS information including a provider count field;
extracting, by circuitry of the reception apparatus, a value of the provider count field, the provider count field identifying the number of different providers that provide LLS information in the portion of the broadcast stream;
determining the number of providers based on the value of the provider count field; and
processing the portion of the broadcast stream to extract the LLS information until the LLS information for each of the different providers is extracted based on the determined number of providers.

2. The method of claim 1, wherein the LLS information is a LLS table that includes a service list table, a rating region table, or system time information.

3. The method of claim 2, wherein
the LLS table includes at least a provider ID, and
the provider count field identifies the provider count minus one.

4. The method of claim 2, wherein the step of processing comprises:
for each LLS table retrieved from the portion of the broadcast stream,
comparing the number of retrieved LLS tables with the number of providers; and
continuing to wait for one or more additional LLS tables in the portion of the broadcast stream when the number of retrieved LLS tables is less than the determined number of providers.

5. The method of claim 1, further comprising:
receiving a digital television broadcast that includes the portion of the broadcast stream.

6. The method of claim 1, wherein the portion of the broadcast stream is a stream of IP packets, the portion of the broadcast stream being identified by a predetermined PLP ID, IP address and port number.

7. The method of claim 6, wherein the LLS information is carried in the payload of the IP packets.

8. A reception apparatus, comprising:
circuitry configured to
receive a portion of a broadcast stream including low level signaling (LLS) information, the LLS information including a provider count field,
extract a value of the provider count field, the provider count field identifying the number of different providers that provide LLS information in the portion of the broadcast stream,
determine the number of providers based on the value of the provider count field, and
process the portion of the broadcast stream to extract the LLS information until the LLS information for each of the different providers is extracted based on the determined number of providers.

9. The reception apparatus of claim 8, wherein the LLS information is a LLS table that includes a service list table, a rating region table, or system time information.

10. The reception apparatus of claim 9, wherein
the LLS table includes at least a provider ID, and
the provider count field identifies the provider count minus one.

11. The reception apparatus of claim 9, wherein the circuitry is further configured to:
for each LLS table retrieved from the portion of the broadcast stream,
compare the number of retrieved LLS tables with the number of providers; and
continue to wait for one or more additional LLS tables in the portion of the broadcast stream when the number of retrieved LLS tables is less than the determined number of providers.

12. The reception apparatus of claim 8, wherein the circuitry is further configured to:
receive a digital television broadcast that includes the portion of the broadcast stream.

13. The reception apparatus of claim 8, wherein the portion of the broadcast stream is a stream of IP packets, the portion of the broadcast stream being identified by a predetermined PLP ID, IP address and port number.

14. The reception apparatus of claim 13, wherein the LLS information is carried in the payload of the IP packets.

15. A non-transitory computer readable medium storing computer-readable instructions therein which when executed by a computer cause the computer to perform a method for provider signaling, the method comprising:
receiving a portion of a broadcast stream including low level signaling (LLS) information, the LLS information including a provider count field;
extracting a value of the provider count field, the provider count field identifying the number of different providers that provide LLS information in the portion of the broadcast stream;
determining the number of providers based on the value of the provider count field; and
processing the portion of the broadcast stream to extract the LLS information until the LLS information for each of the different providers is extracted based on the determined number of providers.
